(19) United States
(12) Patent Application Publication
(10) Pub. No.: US 2020/0319291 A1
(43) Pub. Date: Oct. 8, 2020

(54) METHOD AND APPARATUS FOR INDOOR LOCALIZATION

(71) Applicant: Interdigital Ce Patent Holdings, Paris (FR)

(72) Inventors: Kent Lyons, Mountain View, CA (US); Jean Bolot, Los Altos, CA (US); Naveen Goela, Berkeley, CA (US); Shahab Hamidi-Rad, Sunnyvale, CA (US)

(21) Appl. No.: 16/303,493

(22) PCT Filed: Jun. 30, 2016
(86) PCT No.: PCT/US16/40355

§ 371 Date: Nov. 20, 2018

Related U.S. Application Data
(60) Provisional application No. 62/340,021, filed on May 23, 2016.

(51) Int. Cl. G01S 5/16; G08B 5/36; H04W 4/33; H04W 4/029

(52) U.S. Cl. CPC G01S 5/16; H04W 4/029; H04W 4/33; G08B 5/36

(57) ABSTRACT

Apparatus and method for indoor localization involving sampling illumination in a location such as a room of a building, producing a frequency domain analysis of the illumination, comparing the frequency domain analysis to a reference frequency domain analysis associated with a reference location, and providing a notification indicating a result of the comparison such as whether the location of the sampling is the reference location.

### TECHNICAL FIELD

The present principles relate generally to indoor localization or location detection.

### BACKGROUND

Indoor location determination or indoor localization is an unsolved problem. While GPS is somewhat effective outdoors, it does not work indoors, e.g., inside a home, due to the inability of GPS devices to acquire the GPS satellite signals. Many services and applications can benefit from a scalable indoor positioning technology. Such applications range from indoor location-based advertisements to tracking senior citizens in their homes to ensure their wellbeing.

One indoor positioning approach is to use radio beacons. For example, iBeacon from Apple uses Bluetooth low energy. This requires installing infrastructure (the beacons), and is also unreliable due to multipath of the radiofrequency signal. It is also not very human centric because radio waves pass through walls and determining exactly which room a person is in is difficult. There are other approaches using radio signals such as Wi-Fi that rely upon identifying the unique signature of Wi-Fi radios in a given location. Also, infrared has been used for marking locations. These other systems also require infrastructure such as Wi-Fi or infrared emitters.

### SUMMARY

These and other drawbacks and disadvantages of the prior art are addressed by the present principles, which are directed to providing indoor localization.

In accordance with an aspect of the present principles, a method comprises sampling periodically a first illumination in a first location wherein the first illumination includes a light output by at least one lighting fixture to produce a first plurality of samples of the first illumination, comparing a frequency domain analysis of the first plurality of samples to a second frequency domain analysis of a second plurality of samples of a second illumination in a second location to determine a relationship of the first location to the second location, and producing a notification responsive to the comparison.

In accordance with another aspect of the present principles, a method comprises sampling periodically a first illumination to produce a first plurality of samples of the first illumination, comparing a frequency domain analysis of the first plurality of samples to a second frequency domain analysis of a second plurality of samples of a second illumination including a light output by a lighting fixture to determine a relationship of the first illumination to the second illumination, and producing a notification responsive to the comparison.

In accordance with another aspect of the present principles, a method comprises sampling periodically a first illumination in a first sampling location wherein the first illumination includes a light output by at least one lighting fixture to produce a first plurality of samples of the first illumination, processing the first plurality of samples to produce a first frequency domain analysis of the first illumination, sampling periodically a second illumination in a second sampling location to produce a second plurality of samples, processing the second plurality of samples to produce a second frequency domain analysis of the second illumination, comparing the second frequency domain analysis to the first frequency domain analysis to determine a relationship of the second sampling location to the first sampling location, and producing a notification responsive to the comparison.

In accordance with another aspect of the present principles, a method comprises sampling a first illumination in a first location to produce a first plurality of samples of the first illumination, processing the first plurality of samples to produce a feature vector representing a first high frequency variation of the first illumination, training a classification model using the feature vector to produce a trained classification model, sampling a second illumination to produce a second plurality of samples of the second illumination, processing the second plurality of samples to produce a second feature vector representing the second high frequency variation, feeding the second feature vector to the trained classification model to produce a prediction of a source of the second illumination, and producing a notification that the second illumination is in the first location responsive to the prediction indicating the source of the second illumination comprises the first illumination.

In accordance with another aspect of the present principles, apparatus comprises a sensor and a processor coupled to the sensor and configured to obtain from the sensor a first plurality of samples of a first illumination in a first location, and to produce a notification in response to a comparison of a first frequency domain analysis of the first plurality of samples and a second frequency domain analysis of a second plurality of samples of a second illumination in a second location.

In accordance with another aspect of the present principles, apparatus comprises a photo-sensor configured to receive ambient light incident on the photo-sensor and produce a signal including a high frequency component representing a high frequency variation of the ambient light, a data capture device coupled to the photo-sensor and sampling the signal produced by the photo-sensor to produce a first plurality of samples of a first illumination in a first location and a second plurality of samples of a second illumination, a processor coupled to the data capture device wherein the processor processes the first plurality of samples to produce a first set of feature vectors representing high frequency components of the first illumination, and processes the first set of feature vectors using a classification model to produce a trained classification model, and processes the second plurality of samples to produce a second set of feature vectors representing high frequency components of the second illumination, and processes the second set of feature vectors using the trained classification model to predict a relationship between the second illumination and the first illumination, and further comprises a user interface producing a notification indicating the second illumination is in the first location in response to the relationship indicating the second illumination corresponds to the first illumination.

In accordance with another aspect of the present principles, a system for indoor localization comprises a sensor configured to sample indoor illumination, a processor coupled to the sensor and receiving a first plurality of samples of a first indoor illumination in a first location, and a server receiving the first plurality of samples from the processor and processing the first plurality of samples to produce a first frequency domain analysis of the first plurality of samples and comparing the first frequency domain analysis to a second frequency domain analysis of a second plurality of samples of a second indoor illumination in a second location and producing a notification responsive to a result of the comparing, wherein the result indicates a proximity of the first location to the second location and the notification indicates the proximity.

In accordance with another aspect of the present principles, a non-transitory computer-readable storage medium has a computer-readable program code embodied therein for causing a computer system to perform a method of indoor localization as described herein.

In accordance with another aspect of the present principles, apparatus comprises means for sampling an illumination to produce a plurality of samples representing a switching characteristic of the illumination, means for processing the samples to produce a set of feature vectors representing the switching characteristic of the illumination and for performing a comparison of the set of feature vectors to a light fingerprint representing a switching characteristic of a light source, and means responsive to the comparison for producing a notification indicating whether the illumination includes light produced by the light source.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1A is a diagram showing, in circuit schematic form, an exemplary embodiment of a light source to which the present principles can be applied;

FIG. 1B illustrates characteristics of two exemplary light sources to which the present principles can be applied;

FIG. 2 is a diagram showing exemplary waveforms illustrating aspects of the present principles;

FIG. 3 is a diagram showing additional exemplary waveforms illustrating aspects of the present principles;

FIG. 4 is a diagram showing additional exemplary waveforms illustrating aspects of the present principles;

FIG. 5 is a diagram showing additional exemplary waveforms illustrating aspects of the present principles;

FIG. 6 is a diagram showing an exemplary embodiment of an apparatus and a system in accordance with an aspect of the present principles;

FIG. 7 is a flowchart illustrating an exemplary embodiment of a method of sampling illumination or a sampling mode of operation in accordance with an aspect of the present principles;

FIG. 8 is a flowchart illustrating an exemplary embodiment of a method of training a classification model or a training mode of operation in accordance with an aspect of the present principles;

FIG. 9 is a flowchart illustrating an exemplary embodiment of a method of detecting location or a detecting mode of operation in accordance with an aspect of the present principles;

FIG. 10 is a flowchart illustrating an exemplary embodiment of a method of capturing illumination samples into a file or a capturing mode of operation in accordance with an aspect of the present principles;

FIG. 11 is an illustration of an exemplary embodiment of segmentation of a plurality of light samples in accordance with the present principles;

FIG. 12 is an illustration of a representation in accordance with the present principles of sampled light produced by a first type of exemplary light source; and

FIG. 13 is an illustration of a representation in accordance with the present principles of sampled light produced by a second type of exemplary light source.

In the various figures, like reference designators refer to the same or similar features.

### DETAILED DESCRIPTION

The present principles are directed to indoor localization or identifying a location indoors. While one of ordinary skill in the art will readily contemplate various applications to which the present principles can be applied, the following description will focus on embodiments of the present principles applied to an indoor environment such as a home and mobile devices for localization such as a mobile phone or other mobile devices including wearable devices such as virtual reality (VR) or augmented reality (AR) devices such as headsets or headgear. However, one of ordinary skill in the art will readily contemplate other devices and applications to which the present principles can be applied, given the teachings of the present principles provided herein, while maintaining the spirit of the present principles. For example, the present principles can be applied to other indoor environments such as a commercial business or an office area. In addition, the present principles may be incorporated into various types of mobile devices such as laptops and tablets. Also, some or all of the present principles may be embodied completely in a mobile device or a mobile device may be a component in a system embodying the present principles. For example, aspects of the present principles may involve processing data partially in a mobile device and partially in a device or devices other than a mobile device such as a set-top box, gateway device, desktop computer, server, etc. It is to be appreciated that the preceding listing of devices is merely illustrative and not exhaustive.

In addition, exemplary embodiments described herein may include other elements not shown or described, as readily contemplated by one of skill in the art, as well as omit certain elements. For example, various input devices and/or output devices can be included depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. Control functions may be implemented in software or hardware alone or in various combinations and configurations. Data may be stored in one or more memory devices and the memory devices may be of one or more types such as RAM, ROM, hard disk drives. These and other variations are readily contemplated by one of ordinary skill in the art given the teachings of the present principles provided herein.

In accordance with an aspect of the present principles, a sensor such as a photo-sensor operates to detect the variations in high-frequency switching of regular indoor lighting, i.e., a switching characteristic of an illumination or lighting source. While indoor lighting appears to be always on to the naked eye, most lighting technologies are actually switching on and off at very rapid rates (e.g., LED lights, fluorescents, etc.) Photo-sensors detect that switching, and in particular detect the unique differences in how each light switches. Detecting and evaluating the switching and unique characteristics of a particular illumination in a location, e.g., a light source or a combination of light sources in a room of a home, enables producing a characterization of the illumination. This characterization may be referred to as a “light fingerprint”. A light fingerprint is unique to a particular location such as a particular room in a home or a particular light source such as a particular bulb or lamp or combination of light bulbs or lamps. After determining a light fingerprint in a particular location, that light fingerprint may then be used to determine an associated indoor location or identify a particular light source by, for example, a subsequent comparison of illumination in a location or of a particular light source to known light fingerprints. In a sense, each location or each light turns into its own location beacon without requiring adding infrastructure such as beacon hardware to existing lighting.

In accordance with the present principles, indoor localization may be achieved by sampling the illumination in an area, e.g., by a sensor in a mobile device. For example, a user enters a first location, e.g., a room in a home, with a mobile device including a sensor suitable for performing the sampling described and the illumination is sampled in a first location to produce a first plurality of samples of the illumination. A frequency domain analysis of the first plurality of samples is compared to a second frequency domain analysis of a second plurality of samples of a second illumination in a second location to determine a relationship of the first location to the second location. The frequency domain analysis may be performed by a processor in the mobile device or remotely, e.g., by a remote computer or server. The second location may be the same location as the first location, e.g., the same room of a home, or the second location may be a different location. The second frequency domain analysis may be a reference frequency analysis or reference light fingerprint of the illumination in a room in the home of a user. The reference light fingerprint may have been generated previously and stored in memory accessible to the mobile device, e.g., in a database of light fingerprints for the home that includes a fingerprint for each of some or all of the light sources in the home or for the illumination in each of some or all of various rooms of the home.

A notification is produced in response to the comparison. For example, the comparison may indicate that the second illumination is different from the first illumination, thereby indicating that the light source or light bulb or light fixture producing the first illumination is not the same as the light source producing the second illumination and, therefore, the device performing the sample, e.g., a mobile device, is in a different location, i.e., not in the first location. Or, the comparison may indicate that the second illumination is sufficiently similar to the first illumination to indicate that the light source or lighting fixture producing the first illumination is the same as the lighting fixture or light source producing the second illumination, thereby indicating that the device performing the sampling, e.g., a mobile device, and/or a user of the device is in the first location. The notification may be an indication that is audible or visual or both or the notification may be sent to a remote user (e.g., by sending an email or SMS text message to a designated remote device or by making an automated telephone call to the remote device).

As an example of an embodiment of the present principles, identification of the illumination in a location in accordance with the present principles enables determining a location of a device such as a mobile device, thereby, for example, enabling a remote person to monitor the location of someone having the mobile device such as an elderly family member. As another example, a wearable device such as VR or AR gear operating in accordance with the present principles and worn by a user indoors may detect the indoor location of the VR or AR gear based on or responsive to the illumination in a particular location and adapt or control the VR or AR experience for the user in accordance with the location. For example, one VR or AR experience may be provided when the user is in the kitchen and that experience may change as a user moves throughout the indoor environment, e.g., moving from room to room such as from the kitchen to the den then to the basement, etc.

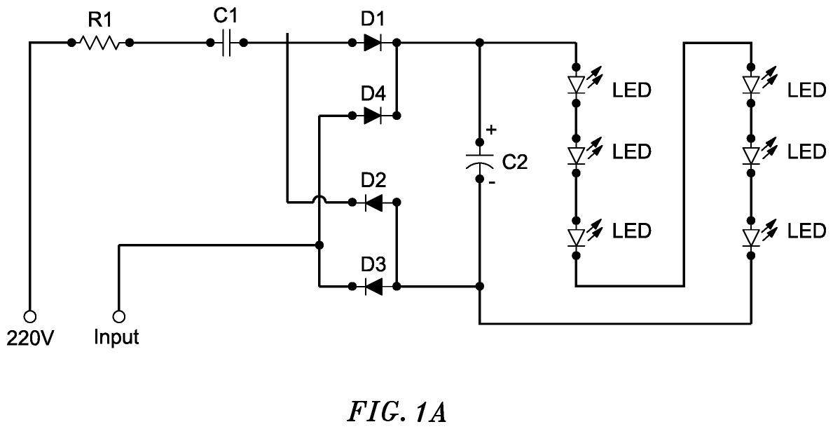

In accordance with aspects of the present principles involving producing and utilizing light fingerprints, indoor lights such as compact fluorescent lights (CFL) and LED lights switch on and off at high frequencies. This switching is not noticeable to people, however can be detected using photo-sensors. Furthermore, due to characteristics of different types of lights and manufacturing variances of the lights, the switching characteristics of each light are unique. For example, the overall cycle time could vary, the rise and fall times of each cycle could be different, the nature of each edge, etc. As shown in FIG. 1A, a typical LED light includes in addition to the LEDs various components such as capacitors and diodes. Variances in these components occur due to component and manufacturing tolerances or other factors. As a result, each LED bulb exhibits different waveforms. Also, different types of bulbs, e.g., CFL and LED, exhibit different light characteristics as shown in FIG. 1B where characteristics of the light signal produced by an ECOSMART CFL light bulb and a CREE LED light bulb are shown for the time and frequency domains (ECOSMART CFL on the left side of FIG. 1B and CREE LED on the right side of FIG. 1B). An aspect of the present principles involves detecting the unique switching characteristics of individual lights.

In accordance with the present principles, a mobile device intended for use for indoor localization would be equipped with a photo-sensor capable of sampling at a frequency capable of detecting the above differences in the light produced by various light sources, bulbs or fixtures. Many mobile devices (smartphones, smartwatches, and even laptops) already have simple sensors to detect ambient illumination for setting backlight brightness. In accordance with the present principles, a similar sensor detects changes in brightness (the switching) at short time scales instead of looking for ambient brightness over large time scales. The pattern of light levels collected by the sensor represents a light or the set of lights in a given area or in other words a light fingerprint.

An aspect of the present principles involves sampling light signals periodically and processing the samples as explained further below. The explanation begins with a continuous signal x(t) which is sampled at a frequency

$${f}_{s} = \frac{1}{T} , or {Ω}_{s} = \frac{2 π}{T} .$$

As an example, an audio signal might be sampled at

$${f}_{s} = \frac{1}{T} = 44100 Hertz ,$$

and a light signal might be sampled on an oscilloscope at

$${f}_{s} = \frac{1}{T} = 0.5 Gigahertz .$$

The sampled signal is denoted by x[n]. Usually, sampling is preferred at a rate above the minimum (e.g., Nyquist rate) to faithfully reconstruct the original continuous signal x(t)and capture all its high frequency oscillations.

The power spectrum of a stochastic stationary signal x[n] is defined as,

Pₓₓ(ω)=Σ_{m=-∞}^{∞}φₓₓ[m]e^{-jωm},

where φₓₓ[m] is the autocorrelation of the signal x[n] . Thus, the power spectrum is the Fourier Transform of the autocorrelation of an (infinite) energy sequence as stated. However, typical situations do not provide an infinite amount of data to represent the signal, and the power spectrum must be estimated based on finite length captured data.

In a typical situation, a signal of finite length L is obtained from data which may be written as a windowed signal,

v[n]=w[n]x[n],

where w[n] is a non-zero window between 0 and L-1, and zero elsewhere. The periodogram provides an estimate of the power spectrum of the signal x[n] as follows,

$${l}_{v v} ( ω ) = \frac{1}{LU} {\sum }_{m = - ( L - 1 )}^{L - 1} {ϕ}_{vv} [ m ] {e}^{- j ω m} ,$$

where the signal φᵥᵥ[m]=Σ_{k=-∞)}^{∞}v[k]v[k+m] is the deterministic autocorrelation of the windowed signal v[n], and U is a normalization constant to remove bias from the window. In order to estimate the power spectrum via the periodogram, to reduce the variance in the estimate, averaging multiple periodograms is usually required to obtain a smooth approximation. The periodogram is evaluated at discrete frequencies:

$${I}_{vv} ( {ω}_{k} )$$

$$where$$

$${ω}_{k} = \frac{2 π k}{N} for k = 1 , 2 , … , N .$$

The main parameters of a basic averaging strategy for periodograms is to specify:

(1) Length of window L;

(2) Window type (e.g., Hamming, Rectangular, Blackman);

(3) Length N of the DFT used in the computation of the periodogram;

(4) Specify any overlap in windowed segments of x[n].

The window type affects spectral leakage in the estimation of the power spectrum. Existing methods such as Welch's method yield unbiased and consistent estimates of the power spectrum.

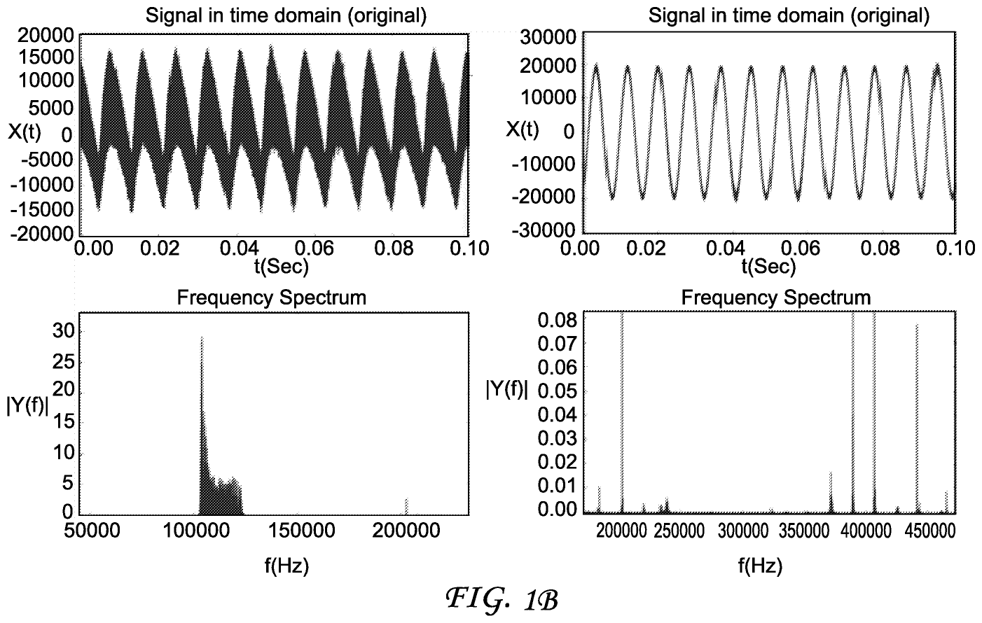

As a first example of fingerprinting signals, consider audio signals. As a specific example, consider 10 seconds of a violin sound versus 10 seconds of a sound track of the sound of bees, signals obtained by sampling at fₛ=44100 Hz yielding 441000 total samples. The two sounds should contain different spectral content which is detectable. Using a Hamming window with no overlaps, L=256, N=2048, the spectral estimate obtained via averaging periodograms is plotted as shown in FIG. 2.

In FIG. 2, the upper line represents the violin audio spectrum, and the lower line represents the bees sound track spectrum. Clearly, the content of the two audio signals is distinguishable, and serves as a finger-print and identification.

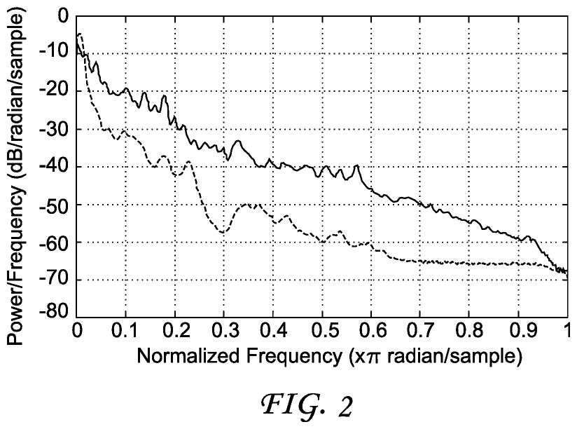

Now consider a square wave oscillation which results from Pulse Width Modulation (PWM) schemes which may drive an illumination source such as LED lights. The duty cycle of a PWM signal may affect the brightness of LEDs for example. Let one square wave be produced with 50% duty cycle, at frequency 1.2 Kilohertz=1200 Hertz, with Gaussian noise added with variance (1/100). Let the sampling frequency be fₛ=10 Kilohertz=10000 Hertz which is above the Nyquist rate. Using a N=4096 DFT for the periodogram, L=256 Hamming window size, and no overlapped windowing, and using data obtained from 10,000,000 samples of the square wave, the power spectrum is estimated as shown in FIG. 3.

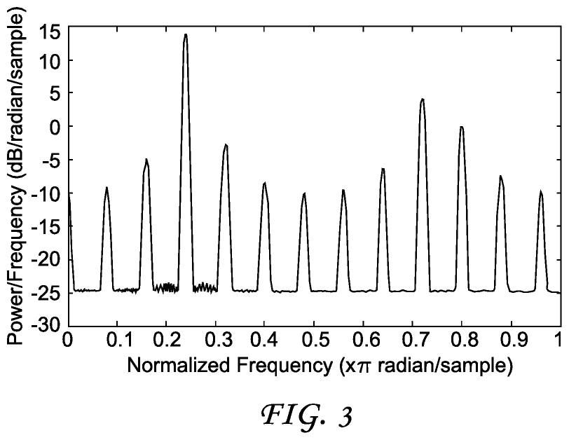

As expected, the peak of the estimated power spectrum occurs at the square wave oscillation frequency of 1200 Hertz. However, there are some other artifacts due to the noise in the signal. Distinguishing two signals with slightly different frequencies of oscillation is shown in FIG. 4. In FIG. 4, the square waves have the main peak at 1150 and 1200 Hertz which is distinguishable in the power spectrum estimation (i.e., there is enough granularity in the DFT of the periodogram).

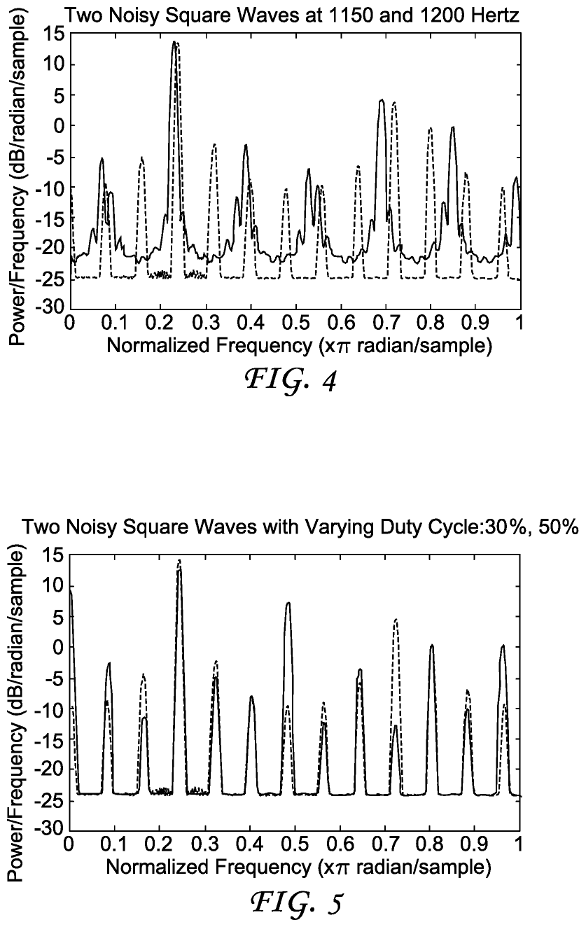

Another example is distinguishing between two square waves with different duty cycles of 30% and 50% as shown in FIG. 5. In FIG. 5, the duty cycle does affect the power spectrum. However, the main maximum frequency of the square wave is still captured. The distinguishability of two spectra may be achieved by measuring the power in the difference between the two spectra.

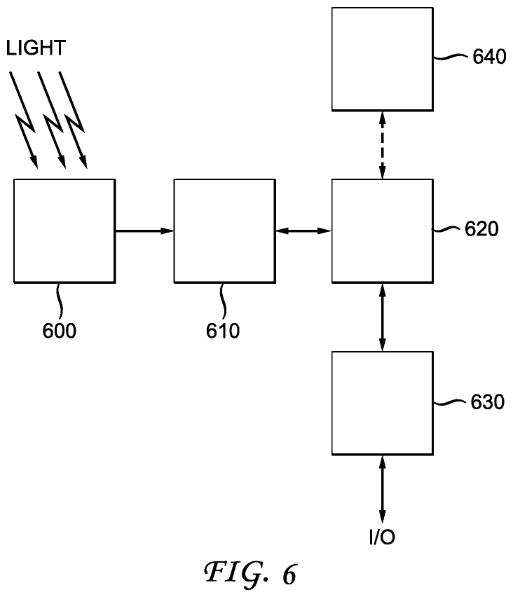

An exemplary embodiment of apparatus or a system in accordance with the present principles is shown in FIG. 6. In FIG. 6, a light sensor 600 receives illumination in a location and generates a signal representative of the magnitude of the illumination. For example, the illumination may be light produced by LED or CFL bulbs in a room of a building such as a home. The sensor responds to rapid fluctuations in the amplitude of the illumination and the signal produced by sensor 600 includes variations representative of high frequency variations in the amplitude of the illumination caused by high frequency switching of the light source as described herein. The high frequency variations may be considered to be a high frequency component of the amplitude that is characteristic of the illumination, e.g., output of a light source or light bulb included in the illumination, that may be used to identify or recognize the light source, i.e., a light fingerprint. An exemplary embodiment of the light sensor comprises a TSL14S light-to-voltage converter manufactured by AMS which includes a built-in pre-amplifier and is capable of capturing light at high frequencies. Various other types of sensors may be used in accordance with the present principles and may be used as a single sensor or in configurations of multiple sensors such as in a sensor array.

As shown in FIG. 6, the output of sensor 600 is coupled to a data acquisition device 610 for sampling the output signal produced by sensor 600. Device 610 produces a plurality of samples representing the illumination of the location, for example, the illumination produced by a light bulb or lighting fixture in the location or by a combination of a plurality of lighting fixtures in a location. An exemplary embodiment of sampling device 610 is a processor such as a PicoScope 2000 manufactured by Pico Technology that includes high-speed data acquisition capability suitable for capturing samples and making the samples available for storage, e.g., by direct storage in local memory or by streaming the samples to enable remote storage such as in a server, and subsequent processing. A variety of devices may provide or be configured to provide the sampling or data acquisition capability of device 610, e.g., such as microprocessors, microcomputers, systems on a chip, various multi-processor arrangements of such devices, laptop computers, tablet computers, etc. may be configured to sample or capture data in accordance with the present principles. Various combinations of a sensor or sensors and one or more sampling or data acquisition devices may be configured to provide various embodiments of means for sampling an illumination in accordance with the present principles.

A processor 620 controls the operation of device 610 in response to control information from control interface 630. For example, processor 620 may include a processor such as Raspberry Pi available from Raspberry Pi Foundation. Processor 620 controls the sampling operation, the data capture of sampling device 610 and the subsequent processing of samples. For example, processor 620 may determine the beginning and end of capturing samples. Processor 620 may determine the storage of samples, e.g., in local or dedicated memory or remote memory as represented by device 640 in FIG. 6. Processor 620 may also control subsequent processing of samples in accordance with present principles. In addition to remote storage, device 640 may also represent a remote processor for providing some or all of the processing of samples. For example, device 640 may be a remote server including memory and processing capability. Rather than processing samples in processor 620, processor 620 may transfer samples to device 640 for storage and processing. Transfer of samples may be by wired or wireless communication means where in FIG. 6 the dashed line connecting processor 620 and server 640 indicates an exemplary wireless communication. Numerous other devices may provide or be configured to provide the processing of device 620 such as microprocessors, microcomputers, systems on a chip, various multi-processor configurations of any such devices, laptop computers, tablet computers, etc. and provide various exemplary means for processing samples of an illumination in accordance with the present principles.

A user interface 630 enables control of processor 620 and sampling by device 610 and may control other devices such as device 640 if such other devices are included. As will be apparent to one skilled in the art, user interface 630 may include one or more of various capabilities such as keypad or keyboard, a touchscreen, a mobile device such as a mobile phone, voice recognition or other audio I/O capability, etc. User interface 630 may be coupled to processor 620 by wired or wireless means. User interface 630 may be simple or complex. An exemplary embodiment of user interface 630 may comprise a small display, e.g., an OLED display, for displaying operating mode or status information, and several pushbuttons for activating various modes of operation as explained in detail below. In addition to providing control as described, user interface 630 may also provide an output such as a notification regarding the status of the processing by processor 620. For example, user interface 630 may produce a notification on a display of the device or communicate a notification to a remote device or user indicating a predicted location of the sampling device as a result of comparing an illumination fingerprint of a current location of the sampling device to a database of reference illumination fingerprints. The various types of user interfaces described herein represent various exemplary embodiments of means for providing or producing a notification in accordance with the present principles.

It will be apparent to one skilled in the art that in accordance with the present principles one or more of the devices shown in FIG. 6 may be in a mobile device and others may be separate. For example, sensor 600, data acquisition device 610, processor 620 and user interface 630 may be included in a mobile device while, as mentioned above, device 640 is an exemplary representation of a processor and/or memory that may be remote, i.e., not included in a mobile device, and may or may not be included in apparatus or a system embodying the present principles.

To provide indoor localization in accordance with the present principles, a light or illumination fingerprint is obtained for at least one indoor location. For simplicity of description, the following detailed explanation will focus on the process for indoor localization in a particular location including obtaining a light or illumination fingerprint for a particular location, e.g., a room of a home. However, as will be apparent to one skilled in the art, the present principles apply to indoor localization in multiple locations by obtaining illumination fingerprints in multiple locations, e.g., a plurality of or all of the rooms in a building or for each light source or light fixture or light bulb in a building. One or more illumination fingerprints may be used as a set of reference fingerprints against which an illumination fingerprint from a particular location may be compared. As an example of operation for indoor localization, a device such as a mobile device constructed and operating in accordance with the present principles moves into a particular room, the device samples the illumination in the room, produces a light fingerprint representing the illumination in the current room or location of the mobile device, and compares the current light fingerprint to one or more reference fingerprints. The location associated with the reference fingerprint that matches the current fingerprint indicates the room or location of the mobile device. A notification may then be produced indicating the location. For example, a notification may be produced by processor 620 and/or user interface 630 responsive to a fingerprint comparison by processor 620. The notification may be displayed on a screen of the mobile device and/or communicated to a remote user, e.g., by sending an SMS text message and/or an email message and/or by making an automated telephone call using any of various communications means including WiFi and communication over the Internet and/or a cell phone capability included in the mobile device. The notification may be of a simple form such as “in the kitchen” or “near the table lamp in the den”. A remote user may use the described notification, and any subsequent updates to the notification as the mobile device moves throughout the building, to track the location of the mobile device and the user of the mobile device.

A notification may also comprise a modification or change or update, e.g., by processor 620 and/or user interface 630 of the exemplary embodiment shown in FIG. 6, of a signal representing a displayed image or a signal intended for display in response to or based on an evaluation of the illumination such as a comparison of a light fingerprint of the illumination to a reference fingerprint as explained herein. For example, a signal representing a display of a map of a building may be updated, e.g., by processor 620 and/or user interface 630, such that the signal when displayed includes a representation of a current location of the device (or a user of the device) on the map, e.g., a displayed icon, responsive to or based on the evaluation of the illumination in various locations in the building. As another example, a notification may comprise modifying, changing or updating a display signal or a signal intended for display on a display such as a wearable display, e.g., a head-mounted display, of a virtual reality (VR) or augmented reality (AR) system. The display signal or signal intended for display may be modified or changed to continually update a displayed image to reflect the current location of a user of the system responsive to or based on the illumination or light sources.

As another example of an embodiment of a notification in accordance with present principles, a notification based on or responsive to evaluating an illumination to determine a location may create or provide a modification or update of control information, e.g., by processor 620 in the exemplary embodiment of FIG. 6, based on the evaluation and a location of a device. For example, the evaluation or comparison may modify control information that is communicated to a home network or home control system to control features in a home based on a device and/or a user's location in the home, e.g., turn off lights after a user leaves a room. As another example, the evaluation or comparison may provide or update control information that controls a system such as a VR or AR system, e.g., updating VR or AR control parameters that modify or control a user's VR or AR experience based on or responsive to a user's location in the home. Thus, as explained herein in reference to various exemplary embodiments, a notification is intended to broadly encompass various embodiments of outputs, results and effects produced in response to or based on location determined in response to or based on evaluation of an illumination such as comparison of a fingerprint or switching characteristic of the illumination to a reference fingerprint or switching characteristic.

In accordance with an aspect of the present principles, a method embodying the present principles may include one or more aspects described below. Similarly, apparatus or a system such as that shown in FIG. 6 may operate in several modes of operation as explained in detail below. These modes of operation include sampling illumination in a location, training a classification model, and detecting location by performing additional sampling in a particular location and using the trained model to identify a light source producing the illumination that was sampled in the location.

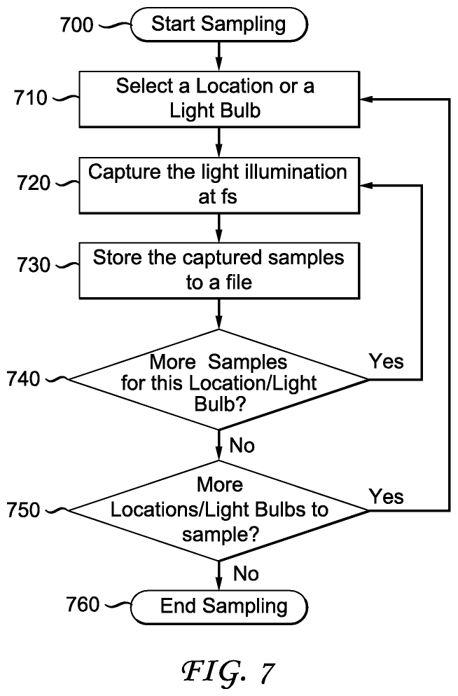

FIG. 7 shows an exemplary embodiment of a method providing a sampling mode of operation of the apparatus in FIG. 6. In FIG. 7, sampling of illumination begins at step 700. At step 710, a particular or first location, light fixture or light bulb is selected. The sensor, e.g., sensor 600 in FIG. 6, is activated to begin sampling at step 720. Sampling occurs periodically at a frequency fs, e.g., 1 MHz or MSPS (1 mega-Hertz or 1 mega samples per second). At step 730, the samples are captured or stored in a file such as in a CSV file (comma separated values format). Each file is named to indicate the particular location or light source, e.g., “light 1” or “location A”. As will be apparent, the file name may also include other information such as a sequence of numbers and/or letters indicating sequence and timing information for a sample. As an example of the preceding operation in regard to the exemplary embodiment shown in FIG. 6, processor 620 (e.g., a Raspberry Pi) sends a command to the data acquisition device 610 (e.g., a PicoScope) to start the sample capture with the specified sample-rate, duration, and scaling information, e.g., using 100 mSec captures at 1 MSPS. Device 610 captures samples of the signal output from the light sensor and provides the samples to processor 620, e.g., by streaming the samples through a connection such as a USB connection to processor 620. Processor 620 stores the samples to a file, e.g., a CSV file, named to indicate the particular light source or location. The file may be stored in processor 620, in memory associated with or coupled to processor 620 within a mobile device or remotely, e.g., in device 640 as shown in FIG. 6. Also as will be apparent to one skilled in the art, alternative embodiments could include storing the samples produced by device 610 within device 610 if device 610 included adequate storage capacity or device 610 could store the samples directly to a separate storage device not shown in FIG. 6, e.g., a hard disk drive attached to device 610. Continuing with FIG. 7, step 740 involves determining if more samples will be acquired for the location or light source selected at step 710. If “yes” at step 740, then operation returns to step 720 and continues again from there. If “no” at step 740, then operation continues to step 750. At step 750, it is determined whether there are more locations or light sources to sample. If “yes” at step 750, then operation returns to step 710 and continues from there. If “no” at step 750, then operation continues to step 760 where sampling ends.

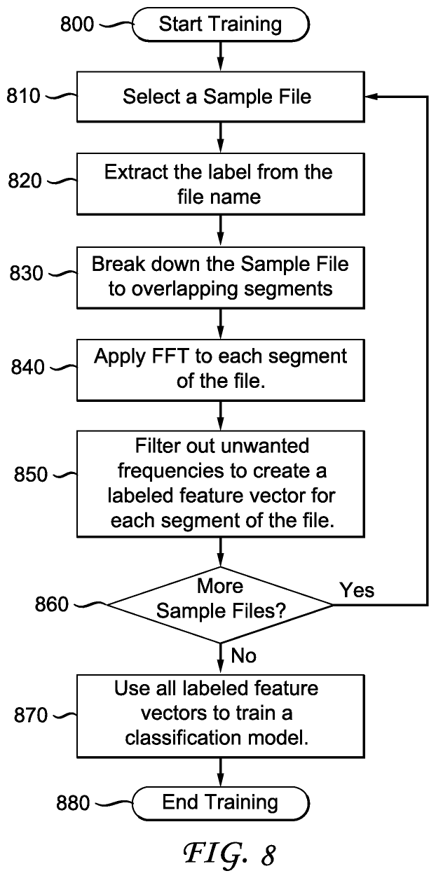

In accordance of aspects of the present principles, completion of sampling as shown in FIG. 7 may be followed in an exemplary embodiment by a method of training or a training mode of operation, e.g., a classification model is trained to classify and recognize, or detect, light fingerprints. FIG. 8 depicts an exemplary embodiment of a method for training or a training mode of operation for apparatus or a system such as that shown in FIG. 6. In FIG. 8, training begins at step 800. At step 810, a file of illumination samples is selected, e.g., one of the CSV format files produced by the exemplary sampling embodiment of FIG. 7 described above. At step 820, a label is extracted from the CSV file name, e.g., for future use to indicate an association of subsequently processed samples with their file, location or light source of origin.

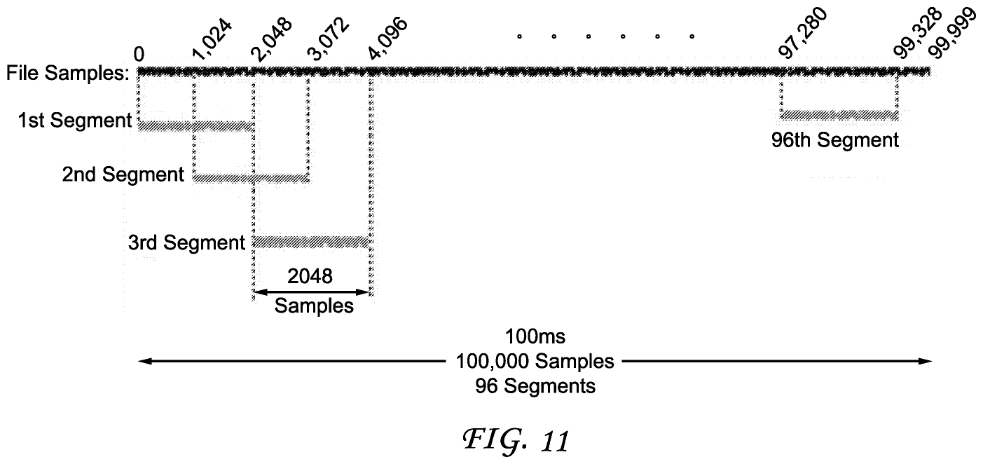

At step 830, the sample file is broken down or segmented into overlapping segments where each segment includes the samples within a particular window or period of time. Parameters used to define the segmentation comprise the length of a segment, e.g., number of samples, and a segment shift value or shift that indicates the shift in time between the start of each segment. If the shift is less than the duration or length of a segment, then the segments overlap. Various segment lengths and various shifts are possible in various combinations. As an example, FIG. 11 shows an embodiment of the segmentation in which 99,328 samples (approximately 1 second of samples at a 1 MSPS sampling rate) is segmented into 96 segments of 100 msec duration each with 2048 samples per segment and with each segment shifted by approximately 50 msec (1024 samples.) That is, a particular segment overlaps each preceding and successive segment by approximately 50% or 50 msec or 1024 samples. The sampling arrangement illustrated in FIG. 11 corresponds to an exemplary embodiment of apparatus such as that shown in FIG. 6 configured with an exemplary choice of parameters in accordance with the present principles comprising a sample duration of 0.1 seconds (100,000 samples at a 1 MSPS sampling rate), a segment length of 2048 samples, and a shift of 1024 samples. This exemplary combination of segment length and shift creates an overlap of approximately 50%.

Returning to FIG. 8, at step 840, FFT (Fast Fourier Transform) as explained above and understood by one skilled in the art is applied to each segment of the file to produce a frequency domain representation of the samples. An exemplary embodiment of a FFT implementation suitable for use with the exemplary embodiment of FIG. 6 comprises a “getSpectrum” function written in the Python programming language and available in the “numpy” extension to the Python programming language. A specific example of an embodiment using the getSprectrum function comprises:

```
def getSpectrum(x,fs):
  “““
  getSpectrum
  Applies FFT on the input data.
  Input:
    x: The time domain signal. This is an array of
    (float) values of the signal in time domain
      fs: Sampling Frequency. This is the number of
    samples per second.
  Output:
    f: The one sided frequency values for each
frequency sample
    y: The actual frequency values. (All Positive
values)
  ”””
  sampleCount = len(x)
  y = (np.abs(np.fft.rfft(x))**2)/sampleCount
  f = np.fft.rfftfreq(sampleCount, 1.0/fs)
  return f,y
```

where the numpy package is imported as np.

In an exemplary embodiment of the method or operation shown in FIG. 8, it may be desirable to perform preprocessing prior to applying the FFT, such as the exemplary getSpectrum function, at step 840. For example, preprocessing may comprise removing the mean value of the signal (the DC value of the signal) and then normalizing all time domain samples to values between −1.0 and 1.0. An exemplary embodiment of such preprocessing for the exemplary apparatus shown in FIG. 6 may comprise two lines of Python code (using the numpy package) that apply these transformations on the time-domain signal x:

| | |
|---|---|
| x -= np.mean(x) | # remove mean |
| x /= np.abs(x).max( ) | # normalize to 1.0 |

At step 850, unwanted frequencies are filtered out. An exemplary embodiment of filtering suitable for use with the described exemplary embodiment of step 840 using the getSpectrum function comprises setting start and end frequencies such as by using the following instructions:

f, y = getSpectrum(x[s:s+SEGMENT_SIZE], SAMPLE_FREQUENCY)
sample = y[startIndex:endIndex]

where the start and end frequencies may be, for example, 30,000 Hz and 115,450 Hz, respectively. Various other start and end frequencies may be used. The result produced by step 850 is a labeled feature vector for each segment of the file. That is, each file (i.e., each sampling of a particular location, illumination or light source) is represented by a number of feature vectors corresponding to the number of segments of the file. Each feature vector provides information regarding a frequency domain representation of the samples processed and includes a representation of a high frequency variation, or high frequency component, of the amplitude variation of the illumination sampled representing, e.g., high frequency switching of a light source that created the sampled illumination.

Step 850 is followed by step 860 which determines whether there are more sample files. If “yes” at step 860 then operation returns to step 810 and continues from there. If “no” at step 860 then operation continues to step 870 where the labeled feature vectors are used to train a classification model to classify, i.e., recognize or detect, data, e.g., to recognize or detect a particular illumination or light source such as a lighting fixture or light bulb that produced a particular collection of samples of illumination from a location. The collection of labeled feature vectors available following step 860 may be viewed as a frequency domain analysis of the illumination in one or more locations or a light fingerprint for one or more locations that will be further utilized as described below. With regard to step 870, it will be apparent to one skilled in the art that various classification models may be used. For example, models such as kNN, Ada-boost, SVM, or CNN may be used. The selection of model may depend on the available processing capability. In an exemplary embodiment such as the apparatus of FIG. 6 embodied in a mobile device, the kNN model may be appropriate. Step 870 is followed by step 880 where training ends. Following the end of training, the result is a trained classification model suitable for classifying or recognizing subsequently provided feature vectors, e.g., from a subsequent sampling session, and the classification results of a subsequent sampling session may be used to recognize or detect a particular light source. If an illumination is recognized, e.g., a light fixture or light bulb is detected, and the location of the recognized light source is known then the location of the sampling of the illumination is known. If the sampling was, e.g., by a mobile device in a room of a home then the location of the mobile device is known to be in the room of the home and indoor localization has been achieved.

With regard to the exemplary embodiment shown in FIG. 6, the data processing steps shown in FIG. 8 may be implemented in processor 620 or in processor 640 or shared between multiple processors such as 620 and 640. As an example, either processor 620 or device 640 may process the files to create the feature vectors (e.g., steps 810 to 860) and processor 640 may perform training of a classification model (e.g., step 870). That is, in an exemplary embodiment, training may occur in a computer, server or processor other than that in a mobile device and may occur “offline”, i.e., at a time and place other than that of the illumination sampling. Then, for example, the trained classification model may be loaded into a mobile device, e.g., processor 620, and used for location detection as explained herein.

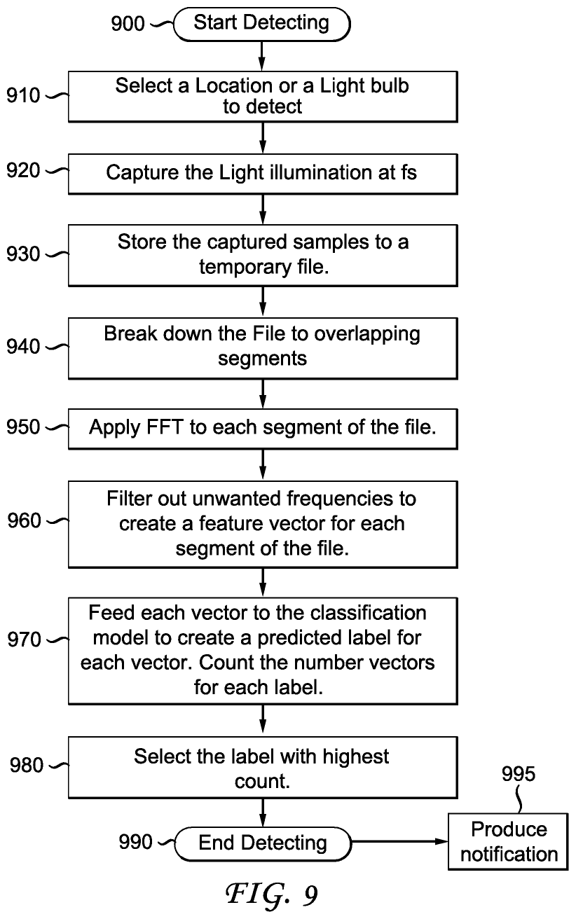

In accordance with aspects of the present principles, completion of training as shown in FIG. 8 and described above may be followed in an exemplary embodiment by a method of detecting or a detection mode of operation as shown, for example, in FIG. 9 to detect a location using a light fingerprint produced as explained herein. In FIG. 9, detection begins at step 900. At step 910, a location, light fixture or light bulb is selected, e.g., the current location of a mobile device including a light sensor in accordance with the present principles. The sensor, e.g., sensor 600 in FIG. 6, is activated to begin sampling and capture samples at step 920. Sampling occurs periodically at a frequency fs, e.g., 1 MHz or MSPS (1 mega-hertz or 1 mega samples per second). At step 930, the captured samples are stored in a file such as in a CSV file (comma separated values format). The file may be a temporary file. As an example of the preceding operation in regard to the exemplary embodiment shown in FIG. 6, processor 620 (e.g., a Raspberry Pi) sends a command to the data acquisition device 610 (e.g., a PicoScope) to start the sample capture with the specified sample-rate, duration, and scaling information, e.g., using 100 mSec captures at 1 MSPS. Device 610 captures samples of the signal output from the light sensor and provides the samples to processor 620, e.g., by streaming the samples through a connection such as a USB connection to processor 620. Processor 620 stores the samples to a file, e.g., a temporary CSV file. The file may be stored in processor 620 or in memory within the mobile device (not shown in FIG. 6) that is associated with or coupled to processor 620. Also, as will be apparent to one skilled in the art, the temporary file may be stored remotely, e.g., in a device such as device 640 in FIG. 6. However, to facilitate mobile detection of location, e.g., as a user moves throughout a home or building, it may be preferable to store the temporary file locally, e.g., within a mobile device.

Continuing with FIG. 9, step 930 is followed by step 940 where the sample file is broken down or segmented into overlapping segments where each segment includes the samples within a particular window or period of time. At step 950, FFT (Fast Fourier Transform) as explained above and understood by one skilled in the art is applied to each segment of the file to produce a frequency domain representation of the samples. Also as explained above, it may be desirable to apply preprocessing such as that described above in regard to FIG. 8 prior to applying the FFT. Following step 950, unwanted frequencies are filtered out at step 960, e.g., in a manner similar to that described in regard to FIG. 8. The result is a set or collection of feature vectors, one feature vector for each segment of the file. That is, each file (i.e., each sampling of a particular location, illumination or light source) is represented by a number of feature vectors corresponding to the number of segments of the file. As in the feature vectors produced by the method shown in FIG. 8, the set or collection of feature vectors produced at step 960 provide a frequency domain analysis or representation of the illumination at the location selected at step 910 that may also be considered to be a light fingerprint of the current location of the device performing the sampling, e.g., a mobile device. The frequency domain representation includes high frequency components of the illumination or light source, e.g., produced by a switching characteristic or characteristics of the light source. In an exemplary embodiment, steps 940, 950 and 960 of FIG. 9 are the same or implement operations similar to those of steps 830, 840 and 850, respectively, of the training method shown in FIG. 8. After step 960, operation continues at step 970 where the feature vectors produced by step 960 are provided to or fed to the trained classification model produced, for example, by the method of FIG. 8. Step 970 creates a predicted label for each vector, i.e., predicts the illumination or light source that produced the vector, and counts the number of vectors for each label. Step 970 is followed by step 980 where the label with the highest count produced at step 970 is selected and designated as the predicted illumination or light source for the samples produced by the illumination or light source selected at step 910.

As described, a prediction of an identification of a particular light source and/or prediction of a location associated with the light source results from use of a trained classification model produced by a training procedure such as that shown in FIG. 8 and described above to evaluate labels of a set of feature vectors produced from a plurality of samples of a particular illumination. Application of classification modelling techniques to a set of feature vectors as described herein may be considered as evaluating or comparing (or a comparison of) a characteristic or characteristics of a particular light source to a reference characteristic of a known light source and/or a known location. For example, a characteristic being evaluated or compared may be considered to be a high frequency component or components of the light source associated with switching of the light source corresponding to high frequency components represented by information included in the set of feature vectors. A comparison as described herein may also be considered to be a comparison of a light fingerprint of one light source, e.g., in a current location, with a reference light fingerprint, e.g., a known light source in a known location. The term comparison as used herein is intended to broadly encompass various embodiments of evaluating switching characteristics or high frequency components or light fingerprints of one light source with respect to another light source, e.g., a reference light source, to determine a correspondence between various sources of illumination or light sources and/or locations associated with light sources. Such embodiments of comparing include but are not intended to be limited to classification techniques as described herein.

Returning to FIG. 9, following step 980, detection ends at step 990 followed by step 995 where a notification is provided. For example, a notification may indicate that the user is in location A or not in location A, e.g., in the kitchen or not in the kitchen. As another example, the indication may indicate that the source of illumination that produced the samples in a particular location is a particular light fixture or light bulb. As another example, the notification may indicate that a user of a mobile device providing the samples is located at or near a particular light source. The indication may be produced locally, e.g., on the mobile device, and/or transmitted to a remote device, e.g., by one or more transmission methods such as text message, email, telephone, WiFi, internet, etc. The indication may take the form of a display of the label for the location or illumination or particular light source that was sampled.

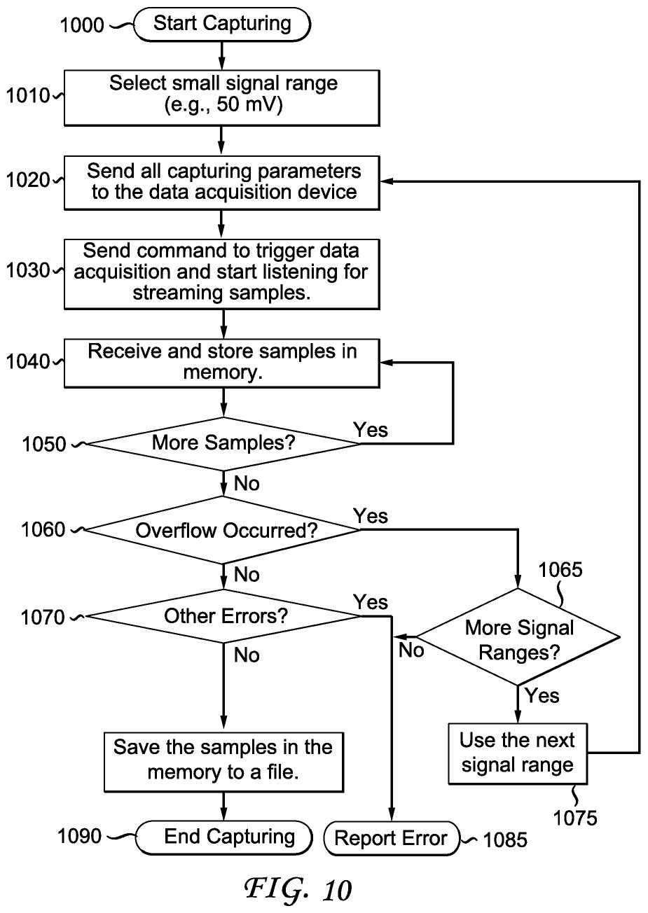

In accordance with another aspect of the present principles, FIG. 10 shows an exemplary embodiment of aspects of the sampling and capturing of samples in a file that is referred to in FIG. 7 at steps 720 and 730 and in FIG. 9 at steps 920 and 930. In FIG. 10, capturing begins at step 1000. An initial signal range for capturing is established at step 1010. To improve sensitivity to light variations, the initial signal range may be selected to be small, e.g., 50 mV. Step 1010 is followed by step 1020 at which capturing parameters in addition to the initial signal range are provided to the data acquisition device. For example, the capturing parameters may include the sampling rate or frequency and the duration of sampling. With regard to the exemplary embodiment shown in FIG. 6, the capturing parameters are provided by processor 620 (e.g., a Raspberry Pi) to data acquisition device 610 (e.g., a PicoScope) via a connection such as a USB connection. Control of processor 620 and acquisition device 610 for selection and delivery of parameters may occur, for example, by a user entering selection and control information via user interface 630.

After step 1020, the data acquisition device is configured for sampling and at step 1030 a command is sent to the data acquisition device to initiate or trigger sampling after which a processor such as processor 620 of the exemplary embodiment in FIG. 6 begins to listen for samples streaming from the data acquisition device. Samples streaming from the data acquisition device are received and stored in memory at step 1040. As discussed above in regard to FIGS. 7 and 9, memory for storage may be local or remote. At step 1050, it is determined whether there are more samples. If “yes” at step 1050 then operation returns to step 1040 to receive and store more samples. If “no” at step 1050 then operation continues at step 1060 where the data is checked to determine if the samples represent an overflow, i.e., the initial signal range set at step 1010 is too small. If “yes” at step 1060 then operation continues at step 1065. If “no” at step 1060, then there is no overflow, i.e., the initial signal range selection was appropriate, and operation continues at step 1070. Step 1070 determines if there are other errors. If “yes” at step 1070 then errors are reported at step 1085 and either the system will take action to correct the errors and/or notify a user of the errors, e.g., in the exemplary embodiment of FIG. 6 processor 620 detects the errors and provides a notification to a user via user interface 630. If “no” at step 1070 then the samples are saved in a file in memory (e.g., at step 730 of FIG. 7 or at step 930 of FIG. 9) and capturing ends at step 1090.

As mentioned, if an overflow is detected at step 1060, i.e., “yes” at step 1060, then operation continues at step 1065 where it is determined whether there are more signal ranges that may be used to attempt to eliminate the overflow. If “yes” at step 1065 the operation continues at 1075 where the next signal range of available signal ranges is selected, e.g., 100 mV, and operation then continues at step 1020 where the new signal range is set in the data acquisition device followed by repetition of the sampling operation of steps 1030 to 1050. If “no” at step 1065 then the overflow error cannot be resolved by changing the signal range and the error is reported at step 1085.

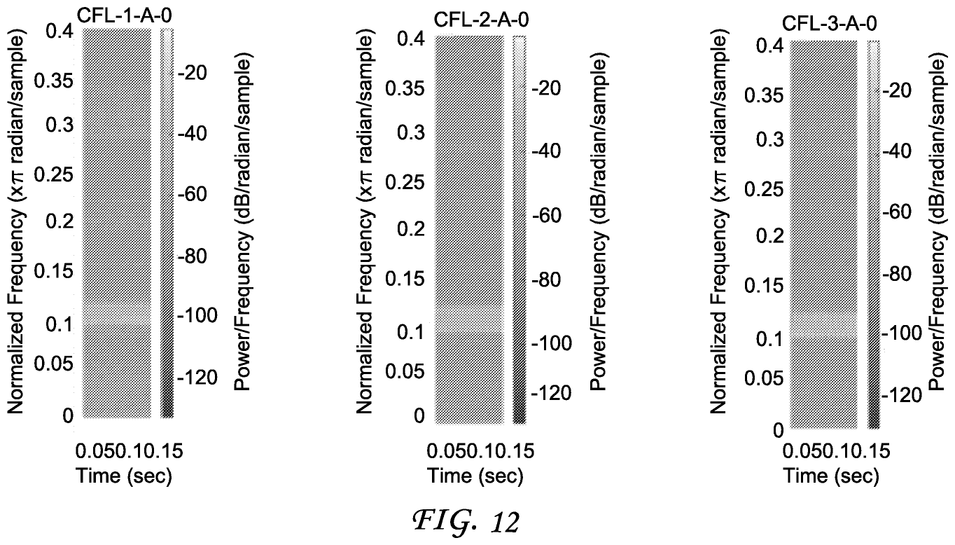

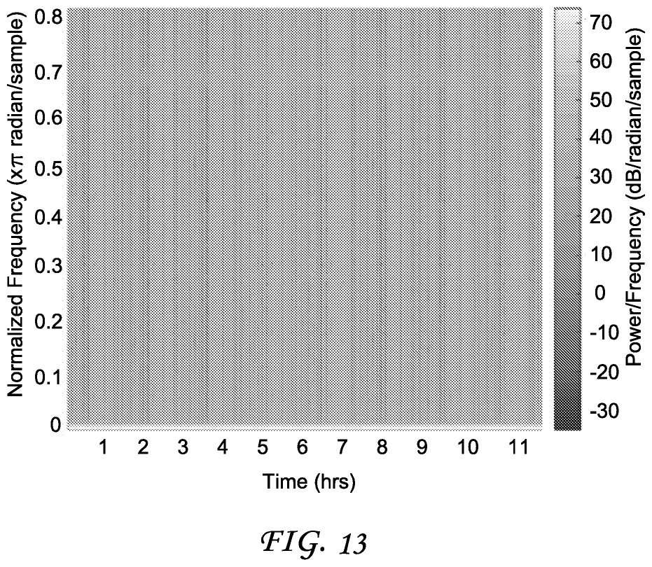

An exemplary result of the sampling and frequency domain analysis, or light fingerprint, of the illumination produced by CFL light bulbs is shown in FIG. 12 which illustrates a light fingerprint for each of three different CFL light bulbs from a particular manufacturer. In FIG. 12, the time period of the analysis or fingerprint is short, e.g., seconds. For comparison, an exemplary result of a frequency domain analysis or light fingerprint of the illumination produced by an LED light fixture is shown in FIG. 13 over a time period of hours. In accordance with the present principles as described herein, light fingerprints such as those shown in FIGS. 12 and 13 may be produced and used for indoor localization such as, for example, when a mobile device in accordance with the present principles enters a room, e.g., a user carries the device into a room. Upon entering a room or after being in a room, the mobile device could initiate a sampling of the light in accordance with the present principles, process the samples to produce a fingerprint of the light, and compare the samples to known fingerprints to identify the source of the illumination in the location, e.g., identify a particular light fixture and locate the mobile device, e.g., the mobile device is in the room that is the location of the identified light fixture. The functions such as sampling, processing the samples to produce a fingerprint, and comparison of the samples to determine a location could occur in the mobile device. Alternatively, the functions could be initiated by the mobile device and performed remotely or partially within the mobile device and partially remotely or completely remotely. Following identification or determination of the location of the mobile device, a notification can be generated by the mobile device or by a remote processor identifying the location of the mobile device. As an example in accordance with the present principles, the notification could be utilized to remotely track the movements of a family member in a home such as the movements of an elderly family member.

The present description illustrates the present principles. It will thus be appreciated that those skilled in the art will be able to devise various arrangements that, although not explicitly described or shown herein, embody the present principles and are included within its spirit and scope. For example, a light fingerprint pattern produced in accordance with the present principles could be processed using a variety of approaches, e.g., a light fingerprint of a room illuminated by multiple light fixtures may be decomposed to extract the signals from individual lights. The fingerprint could be associated with a known map of a home or building, or it could be used as part of a SLAM (simultaneous location and mapping) system to both create a map and determine a location. Comparison of samples from a current location of, e.g., a mobile device, with one or more reference light fingerprints could be under user control to notify a user when a mobile device moves into a particular location or room selected by the user, e.g., a notification when an elder family member moves into the kitchen or into a particular location that may be dangerous. The comparison and notification could be configured under user control to notify a user when a mobile device moves into close proximity to a particular location or within a particular distance of a particular location or moves toward a particular location. The principles described herein could be combined with other localization approaches, e.g., an explicit modulation of the lights.

All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Herein, the phrase “coupled” is defined to mean directly connected to or indirectly connected with through one or more intermediate components. Such intermediate components may include both hardware and software based components.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

It is to be understood that the teachings of the present principles may be implemented in various forms of hardware, software, firmware, special purpose processors, or combinations thereof. Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles.

1. A method comprising:
sampling periodically a first illumination in a first location wherein the first illumination includes a light output by at least one lighting fixture to produce a first plurality of samples of the first illumination;
comparing a frequency domain analysis of the first plurality of samples to a second frequency domain analysis of a second plurality of samples of a second illumination in a second location to determine a relationship of the first location to the second location; and
producing a notification responsive to the comparison.

2. The method of claim 1 wherein the sampling periodically occurs at a sampling frequency producing the first plurality of samples representing a switching characteristic of the at least one lighting fixture.

3. The method of claim wherein the second frequency domain analysis comprises a light fingerprint representing a switching characteristic of the second illumination, and the comparison comprises determining whether the light output by the at least one lighting fixture corresponds to the light fingerprint of the second illumination.

4. The method of claim 1 wherein the notification comprises an indication that the first location is the same as the second location responsive to the comparison determining that the light output by the at least one lighting fixture corresponds to the light fingerprint of the second illumination.

5. The method of claim 1 wherein the sampling of the first illumination comprises sampling by a sensor included in a mobile device located in the first location.

6. The method of claim 1 wherein the notification comprises a communication by the mobile device to a remote user by at least one of an email message and a SMS text message and a telephone call, and wherein the communication indicates that the mobile device is in the first location.

7. The method of claim 1 wherein the first location comprises a room of a building and the at least one lighting fixture comprises at least one of a CFL and a LED light source in the room.

8. A method comprising:
sampling periodically a first illumination to produce a first plurality of samples of the first illumination;
comparing a frequency domain analysis of the first plurality of samples to a second frequency domain analysis of a second plurality of samples of a second illumination including a light output by a lighting fixture to determine a relationship of the first illumination to the second illumination; and
producing a notification responsive to the comparison.

9. The method of claim 8 wherein the notification comprises indicating whether the first illumination includes light produced by the lighting fixture.

10. The method of claim 8 wherein the lighting fixture is in a location, and the notification comprises indicating whether the sampling of the first illumination occurred in the location.

11. The method of claim 8 wherein a mobile device performs the sampling of the first illumination and wherein the notification comprises updating a location status of a user of the mobile device to indicate whether the user is in the location.

12. The method of claim 8 wherein the location comprises a room of a building and the at least one lighting fixture is located in the room and comprises at least one of a CFL and a LED light source.

13. The method of claim 8 wherein the notification comprises a communication by the mobile device to a remote user by at least one of an email message and a SMS text message and a telephone call, and wherein the communication indicates that a user of the mobile device is in the first location.

14. (canceled)

15. (Canceled)

16. A non-transitory computer-readable storage medium having a computer-readable program code embodied therein for causing a computer system to perform the method of claim 1.

17. Apparatus comprising:
a sensor; and
a processor coupled to the sensor and configured to obtain from the sensor a first plurality of samples of a first illumination in a first location, and
produce a notification in response to a comparison of a first frequency domain analysis of the first plurality of samples and a second frequency domain analysis of a second plurality of samples of a second illumination in a second location.

18. The apparatus of claim 17 wherein the processor is configured for sampling periodically a signal produced by the sensor representing light incident on the sensor, and wherein the sampling periodically occurs at a sampling frequency producing the first plurality of samples capturing a switching characteristic of light included in the first illumination and produced by at least one lighting fixture in the first location.

19. The apparatus of claim 18 wherein the second frequency domain analysis comprises a light fingerprint representing a switching characteristic of the second illumination, and the comparison comprises determining whether the light output by the at least one lighting fixture corresponds to the light fingerprint of the second illumination.

20. The apparatus of claim 19 wherein the notification comprises an indication that the first location is the same as the second location responsive to the comparison determining that the light output by the at least one lighting fixture corresponds to the light fingerprint of the second illumination.

21. The apparatus of claim 17 wherein the sensor is included in a mobile device located in the first location.

22. The apparatus of claim 17 wherein the notification comprises a communication by the mobile device to a remote user by at least one of an email message and a SMS text message and a telephone call, and wherein the communication indicates that a user of the mobile device is in the first location.

23 to 30. (canceled)
